(19) United States
(12) Patent Application Publication
(10) Pub. No.: US 2026/0286090 A1
(43) Pub. Date: Sep. 24, 2026

(54) USE OF A LIGNIN-BASED FILLER FOR PRODUCING A POLYMER COMPOSITION

(71) Applicant: UPM-KYMMENE CORPORATION, Helsinki (FI)

(72) Inventors: Barbara GALL, Helsinki (FI); Florian DIEHL, Helsinki (FI)

(21) Appl. No.: 19/473,162

(22) PCT Filed: Apr. 20, 2023
(86) PCT No.: PCT/EP2023/060229

§ 371 Date: Oct. 7, 2025

(51) Int. Cl. C08K 3/04; C08J 3/22

(52) U.S. Cl. CPC C08K 3/04; C08J 3/226; C08J 2323/10; C08J 2323/16; C08J 2367/02; C08J 2367/04

(57) ABSTRACT

Use of a lignin-based filler, the color of which is represented by an L value of 25-50, an a value of 7-15, and a b value of 11-22, for producing a polymer composition, the color of which is represented by an L value of at most 22, an a value of at most 7, and a b value of at most 9, is disclosed. Further is disclosed use of the produced polymer composition and a polymer composition

### FIELD OF THE INVENTION

The present disclosure relates to the use of a lignin-based filler for producing a polymer composition. The present disclosure further relates to the use of the polymer composition produced for packaging applications, automotive applications, construction applications, agriculture applications, and/or electronic applications. The present disclosure further relates to the use of the polymer composition produced for tires, tire treads, tire side walls, cable sheaths, hoses, drive belts, conveyor belts, roll coverings, shoe soles, buffers, sealing rings, profiles, and/or damping elements. Further, the present disclosure relates to a polymer composition.

### BACKGROUND OF THE INVENTION

Carbon black is commonly used as the pigment or filler in black colored plastics. Sustainability of the components of plastic production is of importance and there is a need for biobased and renewable components in the plastics. Therefore, the inventors have recognized an ongoing need to find sustainable solutions for producing renewable black coloring fillers or pigments to be used in different applications to reduce emissions.

### SUMMARY

The use of a lignin-based filler, the color of which is represented by an L value of 25-50, an a value of 7-15, and a b value of 11-22, for producing a polymer composition, the color of which is represented by an L value of at most 22, an a value of at most 7, and a b value of at most 9, is disclosed. The lignin-based filler is used in an amount of 0.5-50 weight-% based on the total weight of the polymer composition. The lignin-based filler is prepared from lignin subjected to hydrothermal carbonization treatment.

Further is disclosed the use of the polymer composition produced by the use as defined in the current specification for packaging applications, automotive applications, construction applications, agriculture applications, and/or electronic applications.

Further is disclosed the use of the polymer composition produced for tires, tire treads, tire side walls, cable sheaths, hoses, drive belts, conveyor belts, roll coverings, shoe soles, buffers, sealing rings, profiles, and/or damping elements.

Further is disclosed a polymer composition, the color of which is represented by an L value of at most 22, an a value of at most 7, and a b value of at most 9, wherein the polymer composition is obtainable by combining a lignin-based filler, the color of which is represented by an L value of 25-50, an a value of 7-15, and a b value of 11-22, with a polymer, wherein the polymer composition comprises lignin-based filler in an amount of 0.5-50 weight-% based on the total weight of the polymer composition, and wherein the lignin-based filler is prepared from lignin subjected to hydrothermal carbonization treatment.

### DETAILED DESCRIPTION

The use of a lignin-based filler, the color of which is represented by an L value of 25-50, an a value of 7-15, and a b value of 11-22, for producing a polymer composition, the color of which is represented by an L value of at most 22, an a value of at most 7, and a b value of at most 9, wherein the lignin-based filler is used in an amount of 0.5-50 weight-% based on the total weight of the polymer composition and wherein the lignin-based filler is prepared from lignin subjected to hydrothermal carbonization treatment, is disclosed.

Further is disclosed the use of the polymer composition produced by the use as defined in the current specification for packaging applications, automotive applications, construction applications, agriculture applications, and/or electronic applications.

Further is disclosed the use of the polymer composition produced for tires, tire treads, tire side walls, cable sheaths, hoses, drive belts, conveyor belts, roll coverings, shoe soles, buffers, sealing rings, profiles, and/or damping elements.

Further is disclosed a polymer composition, the color of which is represented by an L value of at most 22, an a value of at most 7, and a b value of at most 9, wherein the polymer composition is obtainable by combining a lignin-based filler, the color of which is represented by an L value of 25-50, an a value of 7-15, and a b value of 11-22, with a polymer, wherein the polymer composition comprises lignin-based filler in an amount of 0.5-50 weight-% based on the total weight of the polymer composition and wherein the lignin-based filler is prepared from lignin subjected to hydrothermal carbonization treatment.

The polymer composition may comprise polymer in a total amount of 99.5-40 weight-%, or 99-45 weight-%, or 95-50 weight-%, based on the total weight of the polymer composition.

The color of the lignin-based filler may thus vary from brown to black. The inventors surprisingly found out that it is possible to use a brown-shaded lignin-based filler to produce a black-colored polymer composition.

The L, a, and b values indicates values for the color of the lignin-based filler or the polymer composition, respectively. These values may be determined by DIN EN ISO/CIE 11664-1:2020-03. The measurements may be carried out by any device, which allows measurement of the CIELab color space. The use of the lignin-based filler may result in a black colored polymer composition. The polymer composition has the added utility that no other colorants or pigments are needed to achieve the desired color of the polymer composition.

The polymer composition may be a thermoplastic composition or an elastomer composition.

A thermoplastic composition, or thermosoftening plastic composition as it may also be called, is a plastic polymer material that becomes pliable or moldable at a certain elevated temperature and solidifies upon cooling.

An elastomer, or a rubber that it may interchangeably be called, is an elastic material that regain its original shape if it is distorted. Rubber and elastomer are commonly used to mean any material with rubber-like properties. Elastomer is shorthand for elastic polymer. Elastomers are viscoelastic, i.e. they are sticky, very elastic polymers (plastics).

In one embodiment, the lignin-based filler is used in an amount of 0.5-50 weight-%, or 1-40 weight-%, or 2-35, or 3-30, or 5-18 weight-%, or 7-15 weight-%, or 8-12 weight-%, or about 10 weight-%.

In one embodiment, the polymer composition is a thermoplastic composition and the lignin-based filler is used in an amount of 0.5-10 weight-%, or 1-8 weight-%, or 2-7 weight-%, or 3-5 weight-%, based on the total weight of the thermoplastic composition. In one embodiment, the polymer composition is an elastomer composition and the lignin-based filler is used in an amount of 10-50 weight-%, or 12-40 weight-%, or 15-35 weight-%, or 18-30 weight-%, based on the total weight of the elastomer composition.

The “total weight” should in this specification be understood, unless otherwise stated, as the weight of all the components of the polymer composition including possible moisture.

The color of the lignin-based filler may be represented by an L value of 25-50, or 27-45, or 30-40, or 34-38. The color of the lignin-based filler may be represented by an a value of 7-15, or 7.5-13, or 8-11, or 8.5-10. The color of the lignin-based filler may be represented by a b value of 11-22, or 13-20, or 15-18, or 15.5-16.5.

The color of the lignin-based filler may be represented by an L value of 25-50, or 27-45, or 30-40, or 34-38; by an a value of 7-15, or 7.5-13, or 8-11, or 8.5-10; and by a b value of 11-22, or 13-20, or 15-18, or 15.5-16.5.

The color of the polymer composition may be represented by an L value of at most 20, or at most 18, or at most 15, or at most 10. The color of the polymer composition may be represented by an a value of at most 6.7, or at most 6.5, or at most 6. The color of the polymer composition may be represented by a b value of at most 8.7, or at most 8.5, or at most 8.

The color of the polymer composition may be represented by an L value of at most 22, or at most 20, or at most 18, or at most 15, or at most 10; by an a value of at most 7, or at most 6.7, or at most 6.5, or at most 6; and by a b value of at most 9, or at most 8.7, or at most 8.5, or at most 8.

The color of the polymer composition may be represented by an L value of at least 0. The color of the polymer composition may be represented by an a value of at least −50, or at least −30, or at least −10. The color of the polymer composition may be represented by a b value of at least −50, or at least −30, or at least −10.

The color of the polymer composition may be represented by an L value of at least 0; by an a value of at least −50, or at least −30, or at least −10; and by a b value of at least −50, or at least −30, or at least −10.

The lignin-based filler is prepared from lignin subjected to hydrothermal carbonization treatment (HTC). In one embodiment, the lignin-based filler comprises or consists of lignin subjected to hydrothermal carbonization treatment.

Thus, the filler used to make the polymer composition is a lignin-based filler prepared from lignin subjected to hydrothermal carbonization treatment (HTC). The hydrothermal carbonization treatment of lignin refers to a thermochemical conversion process of lignin-containing material in an aqueous suspension. Hydrothermal carbonization treatment of lignin produces lignin derivatives having high carbon content and functional groups.

Lignin is a biopolymer, that is a key structural material in the supporting tissues of most living plants. It is a renewable material which can be used in several applications.

The lignin may be derived from any suitable source. The lignin may be derived from e.g. wood, such as hardwood, softwood, broadleaf wood, or their combination, or from any other biomass such as sugarcane. The wood may originate from e.g. pine, poplar, beech, aspen, spruce, eucalyptus, ash, or birch. The wood may also be any combination or mixture of these.

In one embodiment, the lignin-based filler is prepared from lignin derived from enzymatic hydrolysis process and/or from a Kraft process and subjected to the hydrothermal carbonization treatment. In one embodiment, the lignin-based filler is prepared from lignin derived from enzymatic hydrolysis process and subjected to the hydrothermal carbonization treatment. In one embodiment, the lignin-based filler is prepared from lignin derived from a Kraft process and subjected to the hydrothermal carbonization treatment.

In one embodiment, the enzymatic hydrolysis process comprises enzymatic hydrolysis of a plant-based feedstock, such as a wood-based feedstock. Prior to the enzymatic hydrolysis the wood-based feedstock may have been processed in a pre-treatment process comprising impregnation and hemihydrolysis before the enzymatic hydrolysis. The pretreatment process may result in providing cellulose from the wood-based feedstock, which may then be hydrolysed in the enzymatic hydrolysis process.

In one embodiment, the enzymatic hydrolysis process comprises enzymatic hydrolysis of cellulose. In one embodiment, the lignin-based filler is prepared from lignin derived from pulping of wood, e.g. Kraft lignin.

The lignin-based: filler may be prepared as disclosed below. The lignin to be used may be derived from e.g. a process wherein the lignin is formed in enzymatic hydrolysis of lignocellulosic feedstock or the lignin May be derived from a Kraft process. Also other lignin sources may be used.

In one embodiment, the starting material for preparing the lignin-based filler is lignin taken from enzymatic hydrolysis process. Enzymatic hydrolysis is a process, wherein enzyme(s) assist(s) in cleaving bonds in molecules with the addition of elements of water. In one embodiment, the enzymatic hydrolysis comprises enzymatic hydrolysis of cellulose. In one embodiment, the lignin-based filler is prepared from lignin derived from enzymatic hydrolysis process that is subjected to hydrothermal carbonization treatment.

The inventors surprisingly found out that when e.g. lignin from enzymatic hydrolysis process is used for producing the lignin-based filler, one is able to lower the ash content of the lignin-based filler. The lower ash content has the added utility of e.g. higher purity of the lignin-based filler.

The lignin may originate from second-generation biomass. The second-generation (2G) biomass may be taken to refer to non-edible and non-food biomass. Contrary to the term second-generation biomass, the first-generation biomass is to be taken as edible biomass.

The derived lignin may be dissolved in alkaline solution, such as NaOH. The dissolution may be accomplished by heating the mixture of lignin and alkaline solution to about 80° C., adjusting the pH to a value above 7, such as 9-11, and mixing the mixture of lignin and alkaline solution for a predetermined time. The mixing time may be continued for about 2-3 hours. The exact pH value is determined based on the grade target of the product.

The dissolved lignin may then be subjected to hydrothermal carbonization treatment (HTC).

The hydrothermal carbonization treatment may take place in a reactor (HTC reactor), or if needed, in several parallel reactors, working in a batchwise manner. The dissolved lignin may be pre-heated before being entered in the HTC reactor(s). The temperature in the HTC reactor(s) may be 150-250° C. and the pressure may be 20-30 bar. The residence time in the HTC reactor(s) may be about three to six hours. In the HTC reactor, the lignin is carbonized, whereby a stabilized lignin derivative with a high specific surface area may be precipitated. The formed slurry comprises the carbonized lignin may then be removed and cooled.

Consequently, a slurry comprising lignin-based filler is formed.

The slurry comprising lignin-based filler may be fed to a separation unit, wherein the precipitated lignin may be separated from the slurry. The separated lignin-based filler may be dried and recovered. Before drying, the lignin-based filler may be, if needed, washed. The recovered lignin-based filler may be treated further, e.g. crushed, dried further, milled etc. before using as the lignin-based filler. The thus formed lignin-based filler is a renewable and a biobased filler.

During the above-described process lignin polymers are connected to each other. Thus, the lignin-based filler may be considered to comprise or consist of lignin polymers that are linked together. Lignin polymers that are connected or linked together may not be soluble anymore. However, smaller lignin polymer chains still remain soluble and thus can be subjected to standard analytical techniques like size exclusion chromatography or nuclear magnetic resonance spectroscopy (NMR spectroscopy), which require the analyte to be dissolved in a solvent. Thus, different properties of the soluble fraction of the lignin-based filler may be determined.

In one embodiment, the lignin-based filler comprises ash in a total amount of 0.1-3 weight-%, or 0.1-2.5 weight-%, or 0.2-2.0 weight-%, or 0.3-1.5 weight-%, or 0.4-1.0 weight-%. The ash content can be determined according to the standard DIN 51719.

The inventors surprisingly found out that when e.g. from enzymatic hydrolysis process is used for lignin producing the lignin-based filler, one is able to lower the ash content of the lignin-based filler. The lower ash content has the added utility of e.g. higher purity of the lignin-based filler.

The lignin-based filler may comprise carbon in a total amount of 62-70 weight-%, or 63-69 weight-%, or 64-68 weight-%. The amount of carbon in the lignin-based filler may be determined according to standard DIN 51732 (1997).

In one embodiment, the solubility of the lignin-based filler in 0.1 M NaOH is 1-40 weight-%, or 3-35 weight-%, or 5-30 weight-%. The solubility may be measured in the following manner: First a sample is dried at a temperature of 60° C. for four hours. A sample mass of 0.5 gram is weighed and suspended in 50 ml of 0.1 M NaOH at a concentration of 1% having a temperature of 22° C. Mixing is continued for 1 hour, where after the sample is placed on a glass microfiber paper (1.6 μm) and the filter paper with the sample is dried at a temperature of 60° C. for 2 hours. The portion of the sample has which has dissolved can be determined gravimetrically.

In one embodiment, the lignin-based filler has a weight average molecular weight (Mw) of 1000-4000 Da, or 1300-3700 Da, or 1700-3200 Da, or 2500-3000 Da, or 2600-2900 Da, or 2650-2850 Da, when determined based on the soluble fraction of the lignin-based filler. The weight average molecular weight may be determined with size exclusion chromatography (SEC) by using 0.1 M NaOH as eluent and a sample amount of about 1 mg/ml, which is dissolved in 0.1 M NaOH. The molecular weights are measured against polystyrenesulfonate standards. UV detector at wavelength of 280 nm is used.

The polydispersity index (PDI) of the lignin-based filler may be 1.5-5.0, or 1.8-4.5, or 1.9-4.3, or 2.1-4.0, or 2.4-3.5, or 2.6-3.2, when determined based on the soluble fraction of the lignin-based filler. The polydispersity index may be determined by size-exclusion chromatography (SEC). The PDI is a measure of the distribution of molecular mass in a given polymer sample. The PDI is calculated as the weight average molecular weight (Mw) divided by the number average molecular weight (Mn). PDI indicates the distribution of individual molecular masses in a batch of polymers.

The lignin-based filler may have a STSA number of 3-150 m²/g, or 5-100 m²/g, or 7-60 m²/g. The STSA number may be determined according to standard ASTM D6556.

In one embodiment, the lignin-based filler has a density of at most 1.5 g/cm³. In one embodiment, the lignin-based filler has a density of 1.0-1.5 g/cm³, or 1.15-1.35 g/cm³, or 1.1-1.4 g/cm³. The density may be determined according to standard ISO 21687.

In one embodiment, the polymer composition is a thermoplastic composition, which comprises at least one polymer selected from polyethylene, polypropylene, polystyrene, ethylene-vinyl acetate (EVA), polybutylene adipate terephthalate (PBAT), polyamide, polyacrylate, polyester, acrylonitrile butadiene styrene (ABS), polycarbonate, polylactic acid (PLA), and polyvinyl chloride (PVC). In one embodiment, the thermoplastic composition comprises polyethylene, polypropylene, and/or acrylonitrile butadiene styrene. I.e. one type of polymer may be used for producing the thermoplastic composition or a combination of two or more different polymers may be used.

In one embodiment, the polymer composition is an elastomer composition, which comprises at least one polymer selected from ethylene propylene diene monomer rubber (EPDM), ethylene propylene rubber (EPR), butadiene rubber (BR), chloroprene rubber (CR), epichlorhydrin rubber (ECO), epoxidized natural rubber (ENR), acrylonitrile-butadiene rubber (NBR), hydrogenated nitrile rubber (HNBR), butyl rubber (IIR), isoprene rubber (IR), α-methylstyrene-butadiene rubber (MSBR), natural rubber (NR), styrene-butadiene rubber (SBR), bromobutyl rubber (BIIR) and chlorobutyl rubber (CIIR). I.e. one type of polymer may be used for producing the elastomer composition or a combination of two or more different polymers may be used.

The polymer(s) used in the polymer composition may be derived from (a) fossil resource(s). At least one polymer may be derived from (a) biobased resource(s). The at least one polymer may be derived from a fossil resource or from a biobased resource. All of the polymers used in the polymer composition may be derived either from a fossil source or from a biobased source. Alternatively, polymers from both fossil sources and biobased sources may be used in the polymer composition. Also, a mixture of polymers from both fossil source(s) and biobased source(s) may be used in the polymer composition.

The polymer composition may be prepared by using at least one polymer and the lignin-based filler. Further components or materials, such as plasticizers, additives, lubricants, stabilizers, antioxidants, curing agents, blowing agents, etc., may also be used for preparing the polymer composition. In one embodiment, combining the at least one polymer and the filler comprises also combining one or more plasticizers, additives, lubricants, stabilizers, antioxidants, curing agents, and/or blowing agents, to form the polymer composition.

When preparing the polymer composition, a so-called masterbatch may first be prepared by using the at least one polymer and the filler. The masterbatch may be prepared by mixing the polymer and the filler at an elevated temperature. Also other plasticizers, additives, lubricants, stabilizer, antioxidants, curing agents, blowing agents, etc. as needed may be included in the masterbatch. A masterbatch is generally considered a solid product (normally of plastic, rubber, or elastomer) in which pigments or fillers are optimally dispersed at high concentration in a carrier material. The carrier material is compatible with the main polymer in which it will be blended during molding, whereby the final plastic product, i.e. the polymer composition, obtains the color or properties from the masterbatch.

Alternatively, the polymer composition may be directly compounded at an elevated temperature from the polymer and the filler. Also other additives, lubricants, stabilizers, antioxidants, curing agents, blowing agents, etc. as needed may be directly compounded with the polymer and the filler.

The temperature used when combining the at least one polymer and the filler may vary depending on the type of polymer used. The suitable temperature to be used for each polymer is readily available to the person skilled in the art. Also the polymer providers define suitable processing temperatures for different polymers. Generally, temperatures of e.g 20-350° C., or 40-330° C., or 70-300° C., or 120-280° C., or 150-250° C., may be used.

The polymer composition may be further cured at an elevated in a subsequent step after mixing of the at least one polymer and the filler.

The polymer composition may be non-expanded or expanded. When the polymer composition is expanded it may be taken to have the form of a foam. The expanded polymer composition may be formed by introducing pockets of air or gas (e.g. CO₂) into the polymer composition when being prepared. E.g. blowing agent(s) may be used to expand the polymer composition in order to cause it to foam. Polymer foaming is a process where gas filled cells, bubbles, are introduced to the material structure. With foaming, density of a material can be reduced as less material is consumed. In addition, density of the foam can be controlled, and a broad range of densities can be produced based on the product requirements. This results in reduction of weight and material costs. The expanded polymer composition may also be known as or called foamed polymer composition or polymer foam.

The polymer composition may further be shaped into an article by extrusion, injection molding, compression molding, blow molding, injection blow molding, injection stretch blow molding, thermoforming, vacuum forming, melt spinning, electrospinning, melt blowing, film blowing, film casting, extrusion coating, rotational molding, coextrusion, laminating, calendering, fused deposition modeling, or by any combination of these.

The total organic carbon content of the produced polymer composition may be 90-100%, or 93-99%, or 96-98% as determined according to DIN EN 15936:2012-11. The term “total organic carbon (TOC)” may be taken as the amount of carbon found in an organic compound or in this case in the polymer composition.

The produced polymer composition may comprise ash in a total amount of 0.1-7.5%, or 0.3-7.0%, or 0.5-6%, or 1.0-5.0%, or 1.5-3.0% as determined according to DIN 51719:1997-07.

The amount of renewable materials in the produced polymer composition may be 5-100%, or 10-95%, or 15-90%, or 20-85%.

In one embodiment, the polymer composition does not include any additional colouring agent other than the lignin-based filler.

The use of the lignin-based filler as defined in the current specification has the added utility of providing a black-colored polymer composition without the need to use any other coloring agent(s). The use of the lignin-based filler has the added utility of being a biomaterial and thus the use of which enables the production of a polymer composition where fossil-based components are reduced. The use of the lignin-based fuller has the added utility of increasing the total biogenic carbon content of the polymer composition. Biogenic carbon is the carbon that is stored in biological materials, such as plants or soil. Carbon accumulates in plants through the process of photosynthesis and thus bio-based products may contribute to reduce the levels of carbon dioxide in the atmosphere.

### EXAMPLES

Reference will now be made in detail to the embodiments of the present disclosure.

The description below discloses some embodiments in such a detail that a person skilled in the art is able to utilize the method based on the disclosure. Not all steps of the embodiments are discussed in detail, as many of the steps will be obvious for the person skilled in the art based on this disclosure.

### Example 1—Producing a Polymer Composition by Using a Lignin-Based Filler

In this example different polymer compositions were produced. The purpose was to evaluate the performance and colour of using renewable lignin-based filler (LBF) in different amounts for producing the polymer compositions. Comparative examples were prepared by using no lignin-based filler in the polymer composition.

The lignin-based filler was prepared by following the description provided above in the current specification by using lignin material from enzymatic hydrolysis process of beech wood-based feedstock subjected to hydrothermal carbonization treatment.

Both thermoplastic compositions and an elastomer composition were produced and tested.

The thermoplastic compositions were prepared by combining the lignin-based filler and the thermoplastic polymer and in addition components such as Ca-stearate (lubricant), Irganox 1010 antioxidant, and polyethylene wax (lubricant)). Firstly, masterbatches were formed with a 40 weight-% lignin-based filler load, 52 weight-% of the polymer, and in total 8 weight-% of an additive package (consisting of 2% of Ca-stearate (lubricant), 2% of Irganox 1010 antioxidant, 4% of polyethylene wax (lubricant)), which were then further blended with further polymer to form a lignin-based filler content of 1 weight-%, 3 weight-%, or 5 weight-%.

The masterbatches were formed as granules, which were prepared as follows:

The samples were compounded by using Leistritz ZSE 27 MAXX, i.e. a highspeed co-rotating twin screw extruder with a screw diameter of 27 mm and a L/D of 48. It contained an atmospheric and vacuum degas port, a side feeder for fillers and could be equipped with a melt pump and gas injection units for foaming. The setup was equipped with a Gala PLU Underwater pelletizing system to pelletize the extruded materials into granules.

Then the masterbatch granules are blended with polymer granules (no further additives added) and flat plaques were produced and tested. The flat plaques were prepared by injection moulding the samples on an ARBURG 420 M allrounder 1000-350. The machine was equipped with a quick-change mould for ISO certified test specimens.

As for the pure polymer comparative examples the flat plaques were directly formed from the polymer granules.

The elastomer composition was prepared as follows: In a first mixing step, the lignin-based filler (115 phr), the polymer (EPDM, Keltan 4465, 150 phr), process oil (Tudaen 1924, 25 phr), polyethylene glycol (PEG 4000, 2 phr), stearic acid (2 phr) and zinc oxide (5 phr) were mixed using a laboratory kneader (interlocking internal mixers TMI 0.6 from ERMAFA) for 6.25 min to form a basic mixture. In a second mixing stage, accelerators (MBT 1 phr, ZDTP 2 phr, TBzTD 1.05 phr) and sulphur (1.5 phr) were added to the basic mixture, and everything was mixed for a total of four minutes. The mixtures were then sheeted and cured in a hydraulic press model LP3000 600 kN from MonTech Werkstoffprüfmaschinen GmbH at a temperature of 170° C. for 13 min.

The color of the lignin-based filler and the prepared polymer compositions was measured following standard DIN EN ISO/CIE 11664-1:2020-03. The results are presented below in Table 1:

TABLE 1
Color of the lignin-based filler and the prepared
polymer compositions

| | Color values of the lignin-based filler | | |
|---|---|---|---|
| | L | a | b |
| Lignin-based | 34.33 | 9.17 | 15.85 |
| filler (LBF) | | | |
| sample | | | |

Thermoplastic compositions

| Polymer | Amount of LBF | | | |
|---|---|---|---|---|
| composition | in the polymer | | | |
| Polypropylene | composition | Color values of the polymer composition | | |
| (PP) | (weight-%) | L | a | b |
| | 0 | 78.61 | 2.31 | −5.17 |
| | 1 | 5.17 | 6.67 | 4.42 |
| | 5 | 4.34 | 2.72 | 2.83 |
| | Amount of LBF | | | |
| Low-density | in the polymer | | | |
| polyethylene | composition | | | |
| (LDPE) | (weight-%) | L | a | b |
| | 0 | 72.20 | 2.36 | −4.87 |
| | 1 | 5.88 | 5.05 | 3.74 |
| | 3 | 4.27 | 1.85 | 1.27 |
| Polybutylene | Amount of LBF | | | |
| adipate | in the polymer | | | |
| terephthalate | composition | | | |
| (PBAT) | (weight-%) | L | a | b |
| | 0 | 85.39 | −1.99 | 5.60 |
| | 1 | 16.92 | 6.52 | 7.78 |
| | 5 | 5.28 | 3.05 | 3.02 |
| | Amount of LBF | | | |
| | in the polymer | | | |
| Polylactic | composition | | | |
| acid (PLA) | (weight-%) | L | a | b |
| | 0 | 88.70 | 2.11 | 10.04 |
| | 1 | 14.66 | 6.96 | 8.,49 |
| Elastomer | | | | |
| composition | Amount of | | | |
| Ethylene | LBF in | | | |
| propylene | the polymer | | | |
| diene monomer | composition | | | |
| rubber (EPDM) | (weight-%) | L | a | b |
| | 37.8 | 9.36 | 3.73 | 3.89 |

From the above results one may see that when using the brown-shaded lignin-based filler one is able to produce a black-colored polymer composition.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. Uses and polymer composition as disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A method of producing a polymer composition, the method comprising:
combining at least one polymer with a lignin-based filler, the color of which is represented by an L value of 25-50, an a value of 7-15, and a b value of 11-22, the amount of lignin-based filler being 0.5-50 weight-% based on the total weight of the polymer composition, the lignin-based filler being prepared from lignin subjected to hydrothermal carbonization treatment,
wherein the color of the resulting polymer composition is represented by an L value of at most 22, an a value of at most 7, and a b value of at most 9.

2. The method of claim 1, wherein the polymer composition is a thermoplastic composition or an elastomer composition.

3. The method of claim 1, wherein the polymer composition is a thermoplastic composition and the lignin-based filler is used in an amount of 0.5-10 weight-%, based on the total weight of the thermoplastic composition.

4. The method of claim 1, wherein the polymer composition is an elastomer composition and the lignin-based filler is used in an amount of 10-50 weight-%, based on the total weight of the elastomer composition.

5. The method of claim 1, wherein the color of the lignin-based filler is represented by an L value of 27-45.

6. The method of claim 1, wherein the color of the lignin-based filler is represented by an a value of 7.5-13.

7. The method of claim 1, wherein the color of the lignin-based filler is represented by a b value of 13-20.

8. The method of claim 1, wherein the color of the polymer composition is represented by an L value of at most 20.

9. The method of claim 1, wherein the color of the polymer composition is represented by an a value of at most 6.7.

10. The method of claim 1, wherein the color of the polymer composition is represented by a b value of at most 8.7.

11. The method of claim 1, wherein the lignin-based filler is prepared from lignin subjected to hydrothermal carbonization treatment.

12. The method of claim 1, wherein the polymer composition is a thermoplastic composition, the at least one polymer being selected from polyethylene, polypropylene, polystyrene, ethylene-vinyl acetate (EVA), polybutylene adipate terephthalate (PBAT), polyamide, polyacrylate, polyester, acrylonitrile butadiene styrene (ABS), polycarbonate, polylactic acid (PLA), and polyvinyl chloride (PVC).

13. The method of claim 1, wherein the polymer composition is an elastomer composition, the at least one polymer being selected from ethylene propylene diene monomer rubber (EPDM), ethylene propylene rubber (EPR), butadiene rubber (BR), chloroprene rubber (CR), epichlorhydrin rubber (ECO), epoxidized natural rubber (ENR), acrylonitrile-butadiene rubber (NBR), hydrogenated nitrile rubber (HNBR), butyl rubber (IIR), isoprene rubber (IR), α-methylstyrene-butadiene rubber (MSBR), natural rubber (NR), styrene-butadiene rubber (SBR), bromobutyl rubber (BIIR) and chlorobutyl rubber (CIIR).

14. The method of claim 1, wherein the at least one polymer is derived from at least one fossil resource.

15. The method of claim 1, wherein at least one polymer is derived from at least one biobased resource.

16. The method of claim 1, wherein the polymer composition is configured to be used for packaging applications, automotive applications, construction applications, agriculture applications, and/or electronic applications.

17. The method of claim 1, wherein the polymer composition is configured to be used for tires, tire treads, tire side walls, cable sheaths, hoses, drive belts, conveyor belts, roll coverings, shoe soles, buffers, sealing rings, profiles, and/or damping elements.

18. A polymer composition comprising:
a lignin-based filler in an amount of 0.5-50 weight-% based on the total weight of the polymer composition, the lignin-based filler being prepared from lignin subjected to hydrothermal carbonization treatment; and
at least one polymer,
wherein a color of the polymer composition represented by an L value of at most 22, an a value of at most 7, and a b value of at most 9,
wherein the polymer composition formed by combining the lignin-based filler, the color of which is represented by an L value of 25-50, an a value of 7-15, and a b value of 11-22, with the at least one polymer.
